(19) United States
(12) Patent Application Publication
(10) Pub. No.: US 2011/0134822 A1
(43) Pub. Date: Jun. 9, 2011

(54) MULTICAST AND BROADCAST SERVICE (MBS) MANAGEMENT DEVICE AND METHOD FOR CONFIGURING MBS ZONE IN SINGLE FREQUENCY NETWORK

(75) Inventor: Yong Su LEE, Daejeon (KR)

(73) Assignee: Electronics and Telecommunications Research Institute, Daejeon (KR)

(21) Appl. No.: 12/939,776

(22) Filed: Nov. 4, 2010

(30) Foreign Application Priority Data
Dec. 8, 2009 (KR) 10-2009-0121374
Jul. 20, 2010 (KR) 10-2010-0070193

(51) Int. Cl. H04H 20/71

(52) U.S. Cl. 370/312

(57) ABSTRACT

A multicast and broadcast service (MBS) management device and an MBS zone configuring method by using the same in the single frequency network environment are provided. The MBS management device for controlling the MBS receives position information of a terminal positioned in a cell controlled by a base station within a first tier MBS zone from the base station in order to set the MBS zone. The MBS management device determines whether the terminal is positioned in a boundary area of the cell by using position information of the terminal, and sets an MBS zone of the terminal to include a base station of the neighboring cell in a boundary area of the cell when the terminal is positioned in the boundary area of the cell.

### CROSS-REFERENCE TO RELATED APPLICATION

This application claims priority to and the benefit of Korean Patent Applications No. 1 0-2009-01 21 374 filed in the Korean Intellectual Property Office on Dec. 08, 2009 and No. 10-2010-0070193 filed therein on Jul. 20, 2010, the entire contents of which are incorporated herein by reference.

### BACKGROUND OF THE INVENTION

(a) Field of the Invention

The present invention relates to a multicast and broadcast service (MBS) management device and a method for configuring a multicast and broadcast service (MBS) zone in a single frequency network by using the MBS management device.

(b) Description of the Related Art

In general, a wireless communication system provides the Internet, voice over IP (VoIP), non real-time streaming service, Mobile-WiMAX or WiBro, and multicast and broadcast service (MBS) as major services.

The MBS has attracted attention as a new service from among the services provided by the wireless communication system. The MBS can provide can provide video services such as news, drama, and sports, radio music broadcasting, and data service such as real-time traffic information. Also, the MBS can concurrently transmit various channels of high-quality video and audio with high data rates using the macrodiversity skill.

When the MBS zone is formed by using the macrodiversity skill, a range for configuring the MBS zone becomes more than 2 tiers such that it is very complicated to form the MBS zone and a resource is wasted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a multicast and broadcast service (MBS) management device for simplifying a configuration range of the MBS zone and configuring a multicast and broadcast service zone depending on a position of a terminal in a single frequency network environment, and a method for configuring a multicast and broadcast service zone.

An exemplary embodiment of the present invention provides a method for setting a MBS zone by an MBS management device for controlling a MBS, including: receiving position information of a terminal positioned in a cell controlled by a base station within a first tier MBS zone from the base station; determining whether the terminal is positioned in a boundary area of the cell by using the position information of the terminal; and when the terminal is positioned in the boundary area of the cell, setting an MBS zone of the terminal to include a base station of a neighboring cell in the boundary area of the cell.

Another embodiment of the present invention provides a device, positioned within a first tier MBS zone, for setting a multicast and broadcast service (MBS) zone of a terminal in cooperation with a base station for detecting and transmitting position information of the terminal, including: a terminal position information manager for receiving position information of the terminal from the base station and requesting the position information of the terminal from the base station; and an MBS zone setter for receiving the position information of the terminal from the terminal position information manager, and setting an MBS zone of the terminal to include a base station of a cell that is nearest the terminal in a boundary area of the cell by using the position information when the terminal is positioned in the boundary area of the cell of the base station.

### BRIEF DESCRIPTION OF THE DRAWINGS

FIG. 1 shows a general MBS zone.

FIG. 2 shows a simulation environment for comparing receiving performance of a terminal by dividing positions of the terminal in the MBS zone shown in FIG. 1.

FIG. 3 shows a simulation block diagram for checking receiving performance of a terminal in a simulation environment shown in FIG. 2.

FIG. 4 shows a simulation result of a terminal positioned in a cell boundary area shown in FIG. 2.

FIG. 5 shows a simulation result of a terminal positioned in a central area of a cell shown in FIG. 2.

FIG. 6 shows a system for configuring an MBS zone according to an exemplary embodiment of the present invention.

FIG. 7 shows a configuration of a base station shown in FIG. 6.

FIG. 8 shows a configuration of an MBS management device shown in FIG. 6.

FIG. 9 shows a method for configuring an MBS zone in a system for configuring an MBS zone shown in FIG. 6.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

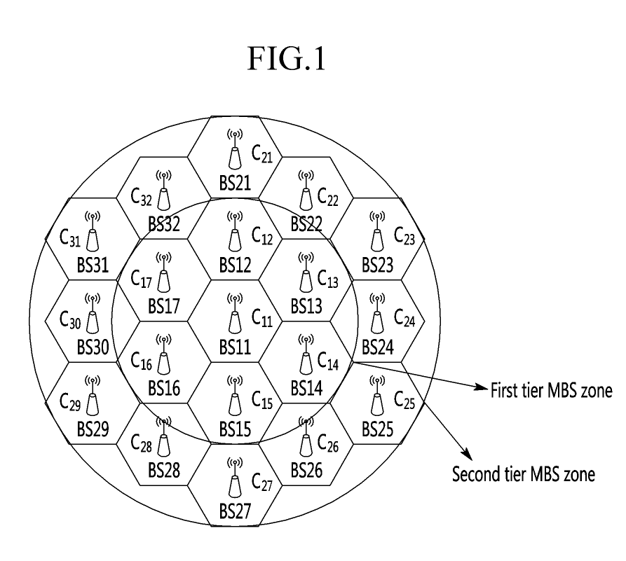

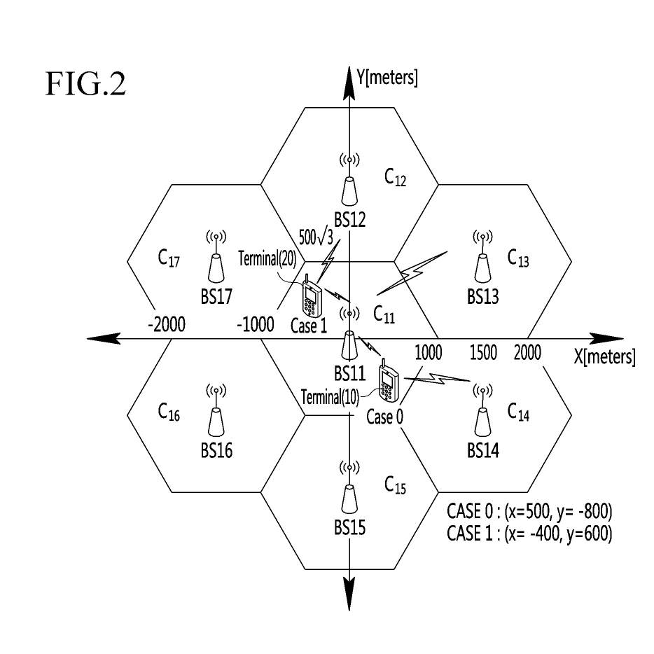

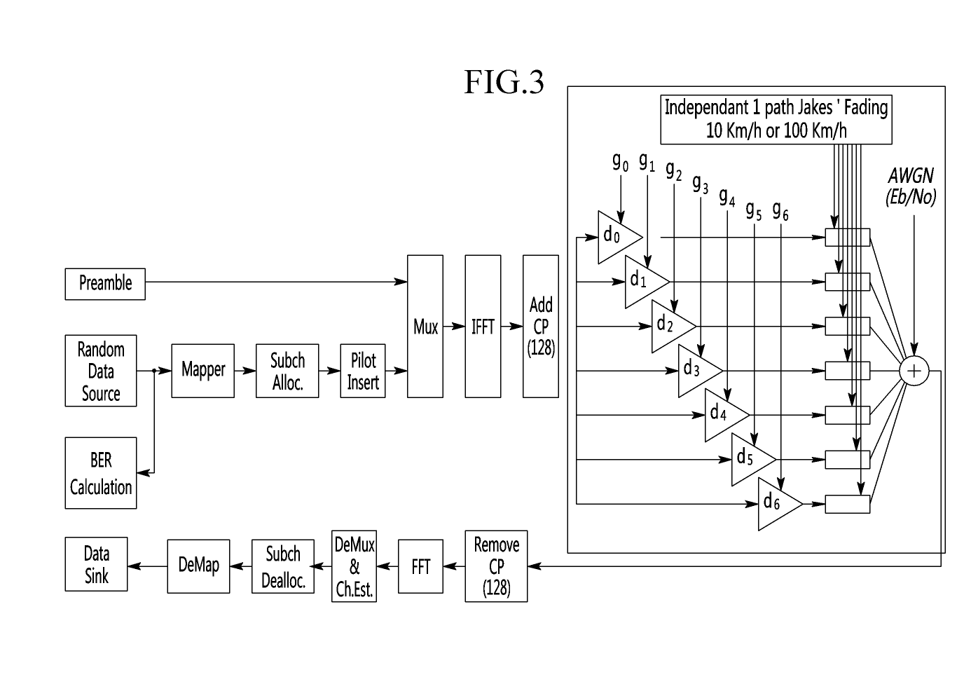

FIG. 1 shows a general MBS zone. FIG. 2 shows a simulation environment for comparing receiving performance of a terminal by dividing positions of the terminal in the MBS zone shown in FIG. 1. FIG. 3 shows a simulation block diagram for checking receiving performance of a terminal in a simulation environment shown in FIG. 2.

As shown in FIG. 1 and FIG. 2, an MBS zone in a general wireless communication system can be configured with at least one MBS zone like a first tier MBS zone and a second tier MBS zone. The first tier MBS zone includes a plurality of cells (C₁₁-C₁₇), and the cells (C₁₁-C₁₇) include base stations (BS₁₁-BS₁₇) respectively and transmit/receive signals to/from terminals. The second tier MBS zone includes a plurality of cells (C₂₁-C₃₂), and the cells (C₂₁-C₃₂) include base stations (BS₂₁-BS₃₂) respectively and transmit/receive signals to/from the terminals.

In order to check receiving performance of the terminal in the MBS zone, the case in which the terminal 20 is positioned in the boundary area of the cells (C₁₁, C₁₄, and C₁₅) from among the first tier MBS zone is set to be the case 0 [Case 0:(x=500, y=−800)], and the case in which the terminal 20 is positioned in the center of the cell (C₁₁) from among the first tier MBS zone is set to be the case 1 [Case 1:(x=−400, y=600)]. Simulation parameters for checking receiving performance of the terminals 10 and 20 are shown in Table 1.

TABLE 1

| Simulation parameters | Values |
|---|---|
| Bandwidth | 8.75 [MHz] |
| Duplexing | TDD |
| Multiple Access Type | OFDMA |
| Modulation | QPSK, 16QAM |
| Sampling Frequency | 10 [MHz] |
| Subcarrier Spacing | 9.765625 [KHz] |
| Frame Length | 5 [msec] |
| Number of Symbols per Frame | 42(DL: 27, UL: 15) |
| OFDMA symbol time | 115.2 [us] |
| FFT Size | 1024 |
| Cyclic Prefix | 128 [samples] |
| Number of Tiers for SFN | 1 |
| Subchannel Allocation | PUSC |
| Channel Estimation | Least Squares |
| Interpolation | Linear |

A normalized delay time (dₙ) when a signal arrives from the base stations (BSᵢ) of the cell neighboring the terminal can be detected by applying the simulation parameters to the simulation block diagram for checking receiving performance of the terminal with reference to FIG. 3, and the normalized delay time (dₙ) is expressed in Equation 1. Here, FIG. 3 represents a simulation block diagram for checking generally-used uncoded bit error ratio (BER) performance, which will not be described.

$$\begin{matrix}{d}_{n} = \frac{\overline{( {BS}_{n} - MS )} - ( {BS}_{0} - MS )}{c} \\ = \frac{\begin{matrix}\sqrt{{( {x}_{{BS}_{n}} - {x}_{MS} )}^{2} + {( {y}_{{BS}_{n}} - {y}_{MS} )}^{2}} - \\ \sqrt{{( {x}_{{BS}_{0}} - {x}_{MS} )}^{2} + {( {y}_{{BS}_{0}} - {y}_{MS} )}^{2}}\end{matrix}}{c}\end{matrix} \qquad ( Equation 1 )$$

Here, [symbol] represents the speed of light, and x_{MS} and y_{MS} indicate the x axis and the y axis of the terminal, respectively. Further, x_{BS} and y_{BS} are coordinates of the x axis and the y axis of the base stations (BSᵢ).

In this instance, the normalized value of a path attenuation degree (gₙ) while the signal reaches the terminal from the neighboring base stations at the position of the terminal is expressed in Equation 2. Here, the path attenuation degree (gₙ) signifies a degree of path attenuation of a signal received from a cell with respect to path attenuation of a signal received by another cell in which the terminal is positioned.

[symbol]

(Equation 2)

Here, RPLₙ, represents relative path attenuation as expressed in Equation 3.

[symbol]

(Equation 3)

Here, RDₙ, shows a relative distance as expressed in Equation 4. In this instance, the relative distance indicates a degree of a path distance of a signal received from another cell versus a path distance of a signal received from the cell in which the terminal is positioned.

[symbol]

(Equation 4)

In this instance, strength of the signal provided to the terminal from the base station is inversely proportional to d⁴.

Here, it is assumed that d⁴=−40 dB/decade.

Results of calculating the delay time (dₙ) and the attenuation degree (gₙ) for the position of the terminal for the first case (Case 0) and the second case (Case 1) by using Equation 1 to Equation 4 are expressed in Table 2.

TABLE 2

| CASE 0 (x = 500, y= −800) | [symbol] | [symbol] [samples] |
|---|---|---|
| Received path order 1: BS₁₁ | g0 = 1 | d0 = 0 |
| Received path order 2: BS₁₄ | g3 = 0.78523881 | d3 = 2 |
| Received path order 3: BS₁₅ | g4 = 0.632904541 | d4 = 4 |
| Received path order 4: BS₁₃ | g2 = 0.055564666 | d2 = 34 |
| Received path order 5: BS₁₆ | g5 = 0.049398519 | d5 = 36 |
| Received path order 6: BS₁₂ | g1 = 0.017851079 | d1 = 55 |
| Received path order 7: BS₁₇ | g6 = 0.017253582 | d6 = 56 |
| CASE 2 (x = −400, y = 600) | [symbol] | [symbol] [samples] |
| Received path order 1:BS₁₁ | g0 = 1 | d0 = 0 |
| Received path order 2: BS₁₇ | g6 = 0.164840804 | d6 = 14 |
| Received path order 3: BS₁₂ | g1 = 0.130122943 | d1 = 16 |
| Received path order 4: BS₁₆ | g5 = 0.023962222 | d5 = 37 |
| Received path order 5: BS₁₃ | g2 = 0.019958571 | d2 = 40 |
| Received path order 6: BS₁₅ | g4 = 0.00862719 | d4 = 55 |
| Received path order 7: BS₁₄ | g3 = 0.008152255 | d3 = 56 |

[symbol]

indicates data missing or illegible when filed

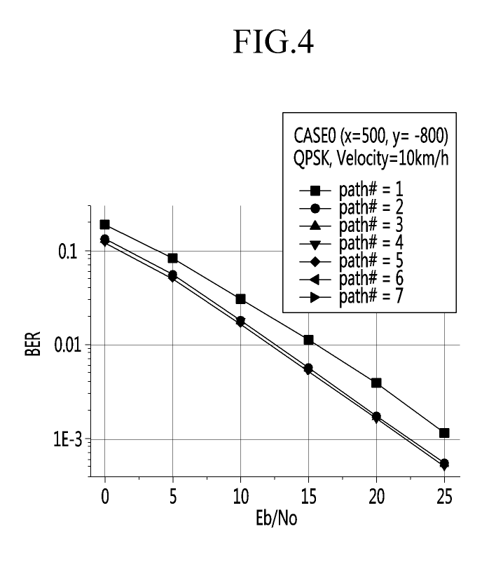

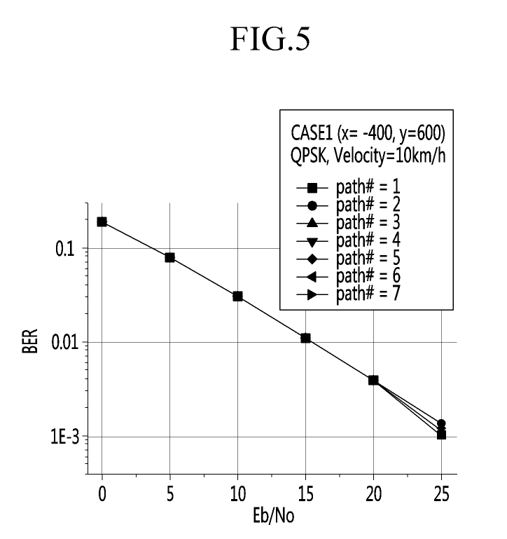

FIG. 4 shows the result of simulating the terminal 10 by applying the values of Table 2 to the simulation block diagram, and FIG. 5 shows the result of simulating the terminal 20.

FIG. 4 shows a simulation result of a terminal positioned in a cell boundary area shown in FIG. 2.

FIG. 4 shows the simulation result found by applying the values of Table 2 in the first case (Case 0) in which the terminal 10 is positioned on the coordinate (x=500, y=−800) of the first tier MBS zone that is a cell boundary area, and path# sequentially indicates the gain (g) and the delay sample (d) starting from the path that is received the most quickly in the first case (Case 0). For example, path#=2 indicates that the first and second paths are received according to the receiving path order and the state of generation of macrodiversity gain is simulated.

The diversity gain that is generated by receiving signals of the base stations BS₁₁ and BS₁₄ of the first and second paths in a like manner of path#=2 is improved by about 3 dB compared to the macrodiversity gain that is received and generated in the base station BS₁₁ of the first path in a like manner of path#=1. Therefore, the macrodiversity gain is generated when the signal of the base station that is nearest the terminal 10 from among the neighboring cells C₁₄ and C₁₅ is received together compared to the case when the signal transmitted by the base station BS₁₁ in the cell C₁₁ is received.

Here, when the path is greater than the case of path#=3, no further macrodiversity gain is gained over the case of path#=2, and hence, in the case of path#=3, the signals transmitted by the base stations positioned in the neighboring cells except the base station that is nearest the terminal 10 do not give an advantage to the macrodiversity gain.

FIG. 5 shows a simulation result of a terminal positioned in a central area of a cell shown in FIG. 2.

Referring to FIG. 5, in the second case (Case 1) in which the terminal 20 is positioned on the coordinate (x=−400, y=600) of the first tier MBS zone that is the cell central area, the simulation result having applied the values of Table 2 shows that no macrodiversity gain has occurred. That is, when the terminal is positioned in the central area of the cell in a like manner of the second case (Case 1) differing from the first case (Case 0), if the bit error ratio (BER) curves between the path#=1 for receiving the first path that is received the earliest and the path#=7 for receiving other paths of the remaining order are compared, there is no difference in the BER curves, and hence, the macrodiversity gain cannot be acquired by using the signals transmitted by the base stations of the neighboring cells.

When the macrodiversity MBS zone is configured for the terminal positioned on the boundary of the cell in the area that is greater than the second tier MBS zone, the resource may be wasted because of a complicated configuration.

A skill for configuring an MBS zone in a single frequency network configuration for solving the problem according to an exemplary embodiment of the present invention will now be described.

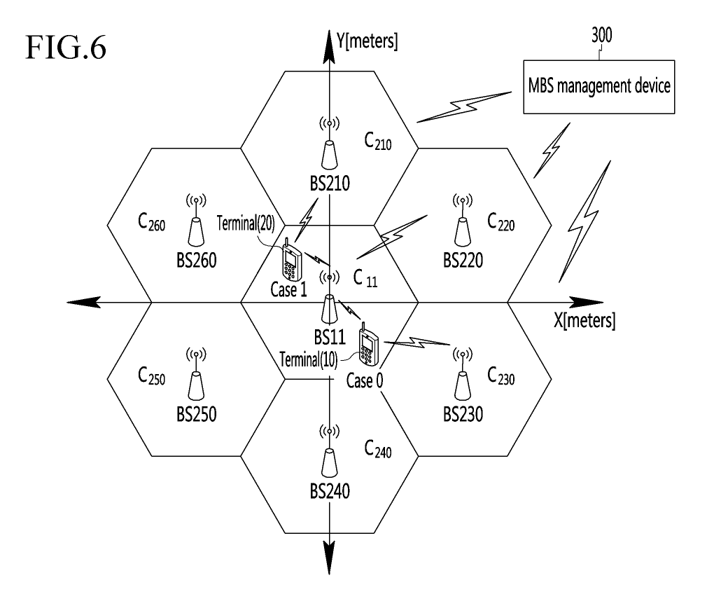

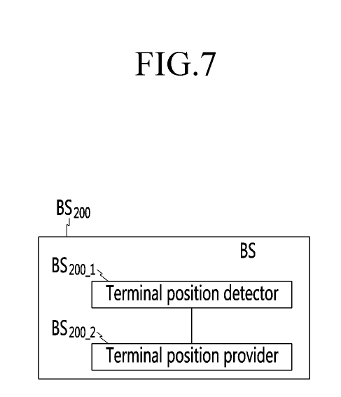

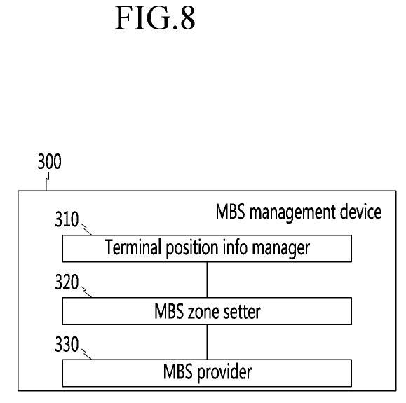

FIG. 6 shows a system for configuring an MBS zone according to an exemplary embodiment of the present invention. FIG. 7 shows a configuration of a base station shown in FIG. 6. FIG. 8 shows a configuration of an MBS management device shown in FIG. 6.

As shown in FIG. 6, the system for configuring an MBS zone according to an exemplary embodiment of the present invention includes a terminal 100, a plurality of base stations (BS₂₀₀-BS₂₆₀), and an MBS management device 300. The system for configuring an MBS zone configures an MBS zone within the first tier MBS zone and also checks the position of the terminal within the first tier MBS zone, and when a terminal is provided in the cell boundary area, it sets the base station that is nearest the corresponding terminal as an MBS zone.

The terminal 100 receives the MBS service through communication with the base station. In this instance, it is assumed for ease of description that the terminal 100 is positioned in the boundary area of the cell C₂₀₀ controlled by the base station BS₂₀₀ and the neighboring cells C₂₃₀ and C₂₄₀. When the MBS management device 300 sets a new MBS zone according to the position of the terminal 100, the terminal 100 receives an identifier of the new MBS zone through the base station BS₂₀₀ and receives corresponding broadcasting data by using the identifier of the MBS zone.

The base stations (BS₂₀₀-BS₂₆₀) provide the MBS service to the terminal 100 through communication with the terminal 100 and the MBS management device 300. A configuration of the base station BS₂₀₀ will be described as representative of the base stations (BS₂₀₀-BS₂₆₀) having the same configuration.

In detail, referring to FIG. 7, the base station BS₂₀₀ includes a terminal position detector (BS₂₀₀-1) and a terminal position provider (BS₂₀₀-2).

The terminal position detector (BS₂₀₀-1) periodically detects the position of the terminal that communicates with the cell C₂₀₀ in which the same terminal is positioned, or detects the position of the terminal when the MBS management device 300 makes a request. The terminal position detector (BS₂₀₀-1) transmits detected position information of the corresponding terminal to the terminal position provider (BS₂₀₀-2).

The terminal position provider (BS₂₀₀-2) provides the position of the corresponding terminal transmitted by the terminal position detector (BS₂₀₀-1) to the MBS management device 300.

Referring to FIG. 6 and FIG. 8, the MBS management device 300 controls the MBS service, detects the position of the terminal 100, and sets the base station that is nearest the corresponding terminal as the MBS zone when the terminal is positioned in the cell boundary area. The MBS management device 300 includes a terminal position information manager 310, an MBS zone setter 320, and an MBS provider 330.

The terminal position information manager 310 periodically receives position information of the terminal from the base station BS₂₀₀. Also, the terminal position information manager 310 request position information of the terminal from the base station BS₂₀₀ if needed. The terminal position information manager 310 transmits the position information of the terminal to the MBS zone setter 320.

The MBS zone setter 320 receives the position information of the terminal from the terminal position information manager 310. The MBS zone setter 320 sets the MBS zone according to the result of determining whether the position of the terminal in the boundary area of the cell by using the position information. In this instance, the MBS zone setter 320 controls the number of base stations configurable in the MBS zone to be not greater than 2 since the macrodiversity gain is generated when the signals transmitted by the base station where the terminal is positioned and transmitted by the base station positioned in the neighboring cell that is nearest the terminal. That is, when the number of base stations configured in the MBS zone is equal to or greater than 3, the number of base stations configurable in the MBS zone is controlled to be not greater than 2 since the macrodiversity gain is no longer improved compared to the case of two base stations in a like manner of the simulation result shown in FIG. 4. The MBS setter 320 classifies the set MBS zone by the identifier and transmits it to the MBS provider 330.

In detail, when the position of the terminal is in the boundary area of the cell, the MBS zone setter 320 sets the MBS zone to include the base station that is positioned in the neighboring cell that is nearest the terminal provided in the boundary area of the cell in the MBS zone of the corresponding terminal. The MBS zone setter 320 classifies the set MBS zone by the identifier and transmits it to the MBS provider 330. For example, when the position of the terminal 100 is in the boundary area of the cell C₂₀₀, the MBS zone setter 320 sets the base station BS₂₃₀ of the cell C₂₃₀ that is nearest from among the cells C₂₃₀ and C₂₄₀ neighboring the terminal 100 to be included in the MBS zone of the corresponding terminal 100. The MBS zone setter 320 classifies the MBS zone including the cells C₂₀₀ and C₂₃₀ by the identifier, and transmits it to the MBS provider 330. When the position of the terminal is not in the boundary area of the cell, the MBS zone setter 320 maintains the currently set MBS zone.

When the terminal 200 in addition to the terminal 100 is provided within the cell C₂₀₀ of the base station BS₂₀₀, and the terminal 200 is positioned in the boundary area that is away by more than a distance to not share the MBS zone of the terminal 100, the MBS zone setter 320 sets another MBS zone within the cell C₂₀₀ so that the base station BS₂₃₀ of the neighboring cell C₂₆₀ from among the cells C₂₁₀ and C₂₆₀ neighboring the boundary area where the terminal 200 is positioned may be included in the MBS zone of the terminal 200. That is, the MBS zone setter 320 sets an MBS zone of the terminal 100 and an MBS zone of the terminal 200 within the cell C₂₀₀ of the base station BS₂₀₀. It has been described in the exemplary embodiment of the present invention that the two terminals 100 and 200 are positioned within the cell C₂₀₀ of the base station BS₂₀₀ and two MBS zones are set within the cell C₂₀₀, but the present invention is not restricted thereto, and a plurality of MBS zones can be set within a single cell according to the distance between the terminals and the conditions.

The MBS provider 330 transmits the identifier of the MBS zone that is set by the MBS zone setter 320 according to the position of the terminal to the corresponding terminal 100 through the base station BS₂₀₀.

A method for setting an MBS zone will now be described.

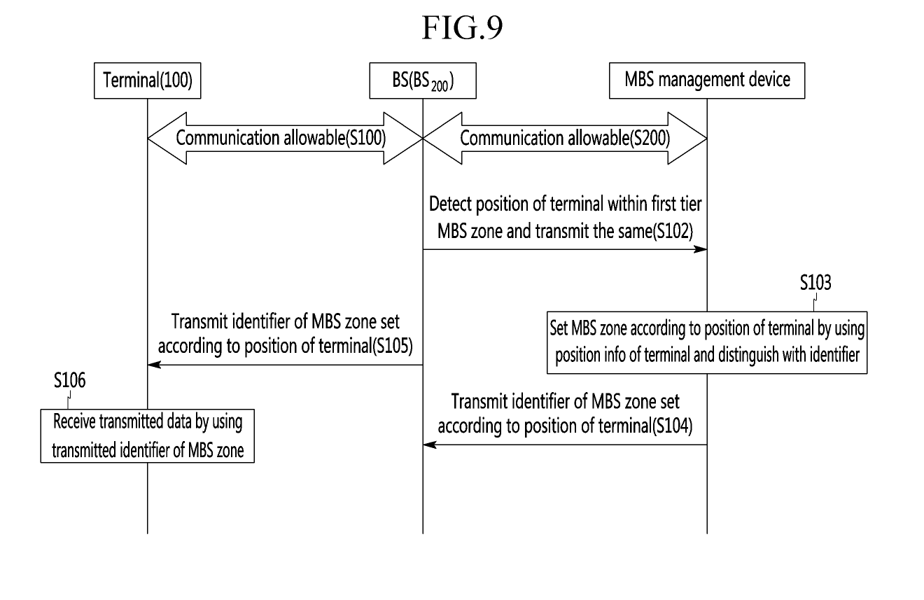

FIG. 9 shows a method for configuring an MBS zone in a system for configuring an MBS zone shown in FIG. 6.

As shown in FIG. 9, the terminal 100 establishes a basic communication channel with the base station BS₂₀₀ for setting an MBS zone, and the base station BS₂₀₀ establishes a basic communication channel with the MBS management device 300 for setting an MBS zone (S100 and S101).

First, the terminal position detector (BS₂₀₀-1) of the base station BS₂₀₀ periodically detects position information of the terminal 100 that communicates with the cell C₂₀₀ in which the terminal position detector (BS₂₀₀-1) is positioned within the first tier MBS zone or detects position information of the terminal 100 when the MBS management device 300 generates a request. The terminal position detector (BS₂₀₀-1) transmits the position information of the terminal 100 detected by the terminal position provider (BS₂₀₀-2) to the MBS management device 300 (S102).

The terminal position information manager 310 of the MBS management device 300 receives the position information of the terminal 100 terminal 100 from the base station BS₂₀₀, and transmits it to the MBS zone setter 320. The MBS zone setter 320 uses the position information of the terminal 100 to set the MBS zone according to the result of determining whether the position of the terminal is in the boundary area of the cell. That is, when the terminal 100 is positioned in the boundary area of the cell C₂₀₀, the MBS zone setter 320 sets the MBS zone to include the base station that is positioned in the neighboring cell that is nearest the boundary area of the cell C₂₀₀, and classifies it by the identifier (S103).

The MBS zone setter 320 transmits the identifier of the MBS zone that is set by the position of the terminal 100 to the base station BS₂₀₀ through the MBS provider 330 (S104). The base station BS₂₀₀ transmits the identifier of the MBS zone to the terminal 100 according to the position of the terminal 100 (S105).

The terminal 100 receives corresponding broadcasting data by using the identifier of the MBS zone that is transmitted through the base station BS₂₀₀ (S106).

Accordingly, the MBS zone can be easily configured by configuring the MBS zone within the first tier MBS zone by applying the macrodiversity skill to the terminal that is positioned in the cell boundary area in the exemplary embodiment of the present invention. Also, the MBS zone can be efficiently configured without wasting the resource by configuring the base station that is nearest the corresponding terminal as the MBS zone when the terminal is positioned in the boundary area of the cell within the first tier MBS zone.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for setting a multicast and broadcast service (MBS) zone by an MBS management device for controlling the MBS, comprising:
receiving position information of a terminal positioned in a cell controlled by a base station within a first tier MBS zone from the base station;
determining whether the terminal is positioned in a boundary area of the cell by using the position information of the terminal; and
when the terminal is positioned in the boundary area of the cell, setting an MBS zone of the terminal to include a base station of a neighboring cell in the boundary area of the cell.

2. The method of claim 1, wherein
the setting includes
distinguishing an identifier of the MBS zone, and transmitting the identifier to the terminal through the base station.

3. The method of claim 1, wherein
the setting includes
setting a number of base stations configurable in the MBS zone of the terminal to be equal to or less than 2.

4. The method of claim 1, wherein,
when a second terminal exists as well as the terminal in the cell and the second terminal is positioned in a boundary area that is far from the terminal by more than a predetermined distance,
the setting further includes
setting an MBS zone of the second terminal in order for the cell to include a base station of the cell that is nearest the boundary area in which the second terminal is positioned.

5. A device, positioned within a first tier MBS zone, for setting a multicast and broadcast service (MBS) zone of a terminal in cooperation with a base station for detecting and transmitting position information of the terminal, comprising:
a terminal position information manager for receiving position information of the terminal from the base station and requesting the position information of the terminal from the base station; and
an MBS zone setter for receiving the position information of the terminal from the terminal position information manager, and setting an MBS zone of the terminal to include a base station of a cell that is nearest the terminal in a boundary area of the cell by using the position information when the terminal is positioned in the boundary area of the cell of the base station.

6. The device of claim 5, wherein
the MBS zone setter sets an MBS zone of the terminal and distinguishes an identifier of the MBS zone.

7. The device of claim 5, wherein the device includes
an MBS provider for receiving an identifier of the MBS zone of the terminal from the MBS zone setter, and transmitting the same to the terminal.

8. The device of claim 5, wherein
the MBS zone setter sets a number of base stations configurable in the MBS zone of the terminal to be equal to or less than 2.

9. The device of claim 5, wherein,
when a second terminal other than the terminal exists in a cell in which the base station is positioned and the second terminal is positioned in a boundary area that is distant from the terminal by more than a predetermined distance,
the MBS zone setter sets an MBS zone of the second terminal in order for the cell in which the base station is positioned to include a base station of the cell that is nearest the boundary area in which the second terminal is positioned.
